(19) United States
(12) Patent Application Publication
(10) Pub. No.: US 2022/0292549 A1
(43) Pub. Date: Sep. 15, 2022

(54) SYSTEMS AND METHODS FOR COMPUTER-AIDED APPRAISAL

(71) Applicant: SERVICELINK IP HOLDING COMPANY, LLC, Pennsylvania, PA (US)

(72) Inventors: Naveen Shambu Gowda, Pittsburgh, PA (US); Henry Lee, Pittsburgh, PA (US); Avishek Mukherjee, Cranberry Township, PA (US); Shuo Wang, Pittsburgh, PA (US); Siyao Lyu, Coraopolis, PA (US); Robert Miller, Hubbard, OH (US)

(21) Appl. No.: 17/459,618

(22) Filed: Aug. 27, 2021

Related U.S. Application Data
(60) Provisional application No. 63/070,691, filed on Aug. 26, 2020.

(51) Int. Cl. G06Q 30/02; G06Q 50/16; G06K 9/00; G06F 21/84; H04W 4/18; G06N 20/00

(52) U.S. Cl. CPC G06Q 30/0278; G06Q 50/16; G06K 9/00671; G06F 21/84; H04W 4/185; G06N 20/00; G06F 2221/2151

(57) ABSTRACT

Systems and methods for computer-aided real estate appraisal using homeowner-directed videography via a personal computer device. The methods include an app on the homeowner device that provides directed videographic-based appraisal through the home. Captured video is then sent to a server for post-processing and analysis, followed by a professional appraisal and issuance of an appraisal report. Various features may modify the videographic data to remove irrelevant data that could bias the appraisal (such as personal information about the seller) and identify data relevant to the appraisal that might otherwise be overlooked. Machine learning models may be used to assess and determine the current state of the property based on the videographic data.

### CROSS-REFERENCE TO RELATED APPLICATIONS

This application claims benefit of U.S. Prov. Pat. No. 63/070,691, filed Aug. 26, 2020, the entire disclosure of which is incorporated herein by reference.

### BACKGROUND OF THE INVENTION

### Field of the Invention

This disclosure is related to the field of real estate appraisal, and more particularly to systems and methods for computer aided real estate appraisal using a personal computing device.

### Description of the Related Art

Property valuation, also sometimes referred to as real estate appraisal, is the process of developing an opinion of the value of a an improved parcel of real property, generally in contemplation of a transaction related to that property, such as a sale, or pledging the property as collateral for a loan or line or credit. Generally, real estate parcels are regarded as inherently unique, and real estate transactions for any given parcel take place relatively infrequently. Assessing the value of the property to be transferred or pledged as collateral thus generally requires an up-to-date real estate appraisal based on the current condition of the property, and the market value of the general area in which the property is situated. Such real estate appraisals form the basis for mortgage lending, collateralizing the property, property tax assessment, and settling legal matters that involve the property, such as estates and divorces.

Because appraising the real estate requires a consideration of all of the factors that are unique to any given piece of property, the real estate appraiser will almost always physically visit the subject property to be appraised and examine, at a minimum, the exterior of the property to get a general assessment of its condition and degree of care that has been exercised in maintaining it. This also gives the real estate appraiser information about the general location of the property and how other properties nearby have been maintained. In many instances, the real estate appraiser will also enter the interior of the subject property for further inspection. This is particularly common for purchase transactions in which the property will change ownership. Conducting this type of real estate property appraisal is a specialized skill that can require thousands of hours of experience to complete credibly. Real estate appraisers must know what to look for, how to identify potential defects or problems that effect safety, soundness and security, as well as the ability to locate comparable properties and provide a credible market assessment. Various levels of certification are offered for real estate appraisers for different types of properties. Although the opinion of the property owner is, generally speaking, legally admissible in any legal proceeding involving the value of the property, the typical homeowner is not allowed to issue an opinion of value for lending purposes.

In connection with a real estate appraisal, the real estate appraiser ordinarily collects evidence to support the appraisal report, including images or video recordings of the subject property. This information may be used both to substantiate and justify the appraisal report long after the fact, if challenged, as well as used as a reference by the real estate appraiser over the course of developing the appraisal report, to remind the real estate appraiser of the condition of the subject property as of the effective date of the appraisal report. Additionally, where lawfully permitted, this videographic evidence can be used by other appraisers to provide a second opinion, or for collaboration purposes in determining how best to deal with unusual situations on any given parcel.

This process typically requires that a real estate appraiser be physically present at the location to be appraised, but this can present complications in certain circumstances. First, properties may be remote, which can require travel time and expense. Second, having the real estate appraiser present at the property requires coordination with the occupant of the property, such as ensuring that the occupants are present, and that pets are secured. Third, by not capturing videography of the subject property, the real estate appraiser must use spot judgment and memory of the condition and features of the subject property; however, questions may later arise that are not adequately supported by not using videography of the property. This can require the real estate appraiser to revisit the subject property, or require the real estate appraiser to make assumptions, which may or may not be accurate, and which in turn may impact the quality of the resulting appraisal report. Fourth, there may be circumstances under which visiting the subject property is simply impossible or impractical, such as during the recent COVID-19 viral outbreak, and during other times of emergency, whether broad based or local. For example, weather emergencies such as blizzards, flooding or power outages may affect access to the subject property, or illnesses or other medical conditions of the occupants may make it difficult for an unrelated third party to visit the subject property. While the occupant, or somebody associated with the occupant, who has access to the subject property could take the required videography, it is unlikely that these individuals have the adequate training and expertise to stage or frame the videography to acquire the required information for a real estate appraisal.

Additionally, part of the real estate appraisal process is measuring dimensions to calculate the square footage of the property. This is important because the square footage is a major factor in the valuation of the subject property, with larger properties generally having more value than smaller properties. Common approaches to acquiring these measurements include the use of various tools, such as measuring tapes and laser measuring devices. However, most of these tools are used by humans, making it difficult to estimate and control for the error rate. This problem is further exacerbated if the individual taking the measurements is an occupant or homeowner of the subject property, who may be unfamiliar with the proper way to measure the room, may lack the appropriate tools, and may not fully appreciate the importance of acquiring exact, consistent measurements.

Another problem with self-inspection is the correct classification of the interior rooms of the subject property. The proper classification of a room is often defined with respect to building codes. For example, generally, a room cannot be considered a bedroom if it does not have adequate egress in the event of a fire or other emergency requiring evacuation. However, occupants of the subject property often overlook these distinctions, and may count rooms as bedrooms that are not bedrooms as that term is defined in applicable building codes. Certain types of rooms are also very important to the residential real estate appraisal process, especially bedrooms and bathrooms. Thus, it is important that the number of bedrooms and bathrooms be accurately counted.

### SUMMARY OF THE INVENTION

The following is a summary of the invention in order to provide a basic understanding of some aspects of the invention. This summary is not intended to identify key or critical elements of the invention or to delineate the scope of the invention. The purpose of this section is to present some concepts of the invention in a simplified form as a prelude to the more detailed description that is presented later.

Because of these and other problems in the art, described herein, among other things, is a method for computer-aided appraisal of real estate comprising: providing a mobile device of a user conducting a self-inspection appraisal of an appraisal property, the mobile device having an imaging system and a geolocation system; providing an appraiser computer of an appraiser; providing a server computer; while the user is at the appraisal property, the user capturing videographic data about the appraisal property using the imaging system of the mobile device; during the capturing: the geolocation system geotagging at least some of the captured videographic data to create geolocation data representing at least one set of geographic coordinates at which the videographic data was captured; the mobile device creating at least one timestamp representing a date and time at which the videographic data was captured; storing the videographic data, the at least one set of geographic coordinates, and the at least one timestamp on a memory of the mobile device; the mobile device transmitting to the server computer via a telecommunications network a copy of the stored videographic data, the at least one set of geographic coordinates, and the at least one timestamp; receiving, at the server computer via the telecommunications network, the transmitted copy of the stored videographic data, the at least one set of geographic coordinates, and the at least one timestamp; conducting, at the server computer, image processing on the received videographic data, the conducting being performed at least in part by an image processing artificial intelligence system; storing the processed videographic data in a non-transitory memory; accessing, by an appraiser using the appraiser computer, via a telecommunications network, the stored and processed videographic data; and viewing, by the appraiser at the appraiser computer, the accessed videographic data; and the appraiser determining an appraisal value for the appraisal property at least in part based upon the viewing.

In an embodiment of the method, the method further comprises confirming that the videographic data is for the appraisal property by, at the server computer, comparing the received geographic coordinates to an independently determined second set of geographic coordinates for the appraisal property.

In another embodiment of the method, the method further comprises confirming that the videographic data is current by, at the server computer, comparing the received timestamp data to the current date and time.

In another embodiment of the method, the method further comprises: receiving, at the mobile device from the server computer over a telecommunications network, a set of instructions for conducting the capturing videographic data about the appraisal property, the instructions being specific to the appraisal property; and wherein the capturing videographic data about the appraisal property comprises displaying, on a display of the mobile device, the received instructions.

In another embodiment of the method, the capturing videographic data about the appraisal property using the imaging system of the mobile device comprises acquiring, at the mobile device, dimension data for at least one room of the appraisal property.

In another embodiment of the method, the acquiring dimension data for the at least one room of the appraisal property includes using an augmented reality module to create a three-dimensional augmented reality model of the at least one room.

In another embodiment of the method, the using an augmented reality module to create a three-dimensional augmented reality model of the at least one room comprises: panning the mobile device to capture videographic data of the at least one room; detecting at least one room boundary in the captured videographic data of the at least one room; creating, in the augmented reality model, a geometric plane corresponding to the detected room boundary; displaying, on a display of the mobile device, the geometric plane as an augmented reality element corresponding to the detected room boundary; and repeating the panning, detecting, creating, and displaying.

In another embodiment of the method, the method further comprises: the user manipulating a graphical user interface of the mobile device to identify in the augmented reality model a plurality of corners of the at least one room; and the augmented reality module creating a polygon from the plurality of corners representing the room boundaries of the at least one room; and estimating the dimensions of the room by calculating the dimensions of the edges of the polygon.

In another embodiment of the method, the conducting image processing on the received videographic data comprises: identifying, in the received videographic data, at least one privacy artifact; modifying the received videographic data to obscure the identified at least one privacy artifact; and during the viewing, by the appraiser at the appraiser computer, the accessed videographic data, the at least one privacy artifact is unidentifiable by the appraiser.

In another embodiment of the method, the at least one privacy artifact is selected from the group consisting of: a face; a pet; an indication of political or religious affiliation; an indication of marital status; an indication of sexual orientation; a photograph; text; and numbers.

In another embodiment of the method, identifying, in the received videographic data, at least one privacy artifact comprises creating a plurality of still images from the videographic data and, using an object detection inference engine trained to recognize privacy artifacts, detecting in at least one still image of the plurality of still images the at least one privacy artifact.

In another embodiment of the method, modifying the received videographic data to obscure the identified at least one privacy artifact comprises, at a location in the each at least one still image at which the at least one privacy artifact is detected, replacing the videographic data at the location with obscuring data.

In another embodiment of the method, the obscuring data is at least one member of the group consisting of: black pixels; white pixels; random pixels; a blurring effect causing the at least one artifact to be unidentifiable.

In another embodiment of the method, the conducting image processing on the received videographic data comprises: identifying, in the received videographic data, at least one candidate appraisal artifact; modifying the received videographic data to emphasize the at least one candidate appraisal artifact; creating a time index for the received videographic data, the time index including a tag representing a point in time in the videographic data when the at least one candidate appraisal artifact is visible; during the viewing, by the appraiser at the appraiser computer, the accessed videographic data, the appraiser indicating whether the at least one candidate appraisal artifact is an appraisal artifact; and training, using the indication whether the at least one candidate appraisal artifact is an appraisal artifact, the image processing artificial intelligence system

In another embodiment of the method, the method further comprises: during the viewing, by the appraiser at the appraiser computer, the accessed videographic data: indicating, by the appraiser, at least one non-obscured privacy artifact in the videographic data; training, using the indicated non-obscured privacy artifact, the image processing artificial intelligence system; and modifying the stored videographic data to obscure the indicated privacy artifact.

In another embodiment of the method, the capturing videographic data about the appraisal property using the imaging system of the mobile device includes the user capturing videographic data about a plurality of rooms of the appraisal property and, for each room in the plurality of rooms, manipulating a graphical user interface of the mobile device to indicate a room classification for the each room.

In another embodiment of the method, prior to the user manipulating the graphical user interface of the mobile device to indicate a room classification for the each room: recognizing, by an imagine recognition module, in the videographic data, at least one object in the each room, the at least one object being associated with a room category; and displaying, to the user via the graphical user interface, the room category as a suggested room classification for the each room.

In another embodiment of the method, the mobile device comprises an extended reality headset.

In another embodiment of the method, the method further comprises: at the server computer, an appraisal engine calculating an appraisal estimate for the appraisal property, the appraisal estimate based on the received videographic data, the at least one set of geographic coordinates, and the at least one timestamp.

In another embodiment of the method, the method further comprises: comparing the appraisal value of the appraisal to the calculate appraisal estimate; if the difference between the appraisal value of the appraisal and the calculate appraisal estimate exceeds a predefined threshold, a second appraiser reviewing the appraisal value.

### BRIEF DESCRIPTION OF THE DRAWINGS

FIG. 1 depicts a schematic diagram of an embodiment of a system and method for computer-aided appraisal of real estate according to the present disclosure.

FIG. 2 depicts a flow chart of an embodiment of a system and method for estimating dimensions in a computer-aided appraisal system according to the present disclosure.

FIG. 3 depicts a flow chart of an embodiment of a system and method for categorizing data based on context information in a computer-aided appraisal system according to the present disclosure.

FIG. 4 depicts a flow chart of an embodiment of a system and method for transferring operational control of an authenticated user session among multiple devices in a computer-aided appraisal system according to the present disclosure.

FIG. 5 depicts a flow chart of an embodiment of systems and methods for redacting sensitive or private information from image data collected using a computer-aided appraisal system according to the present disclosure.

### DESCRIPTION OF THE PREFERRED EMBODIMENT(S)

The following detailed description and disclosure illustrates by way of example and not by way of limitation. This description enables one skilled in the art to make and use the disclosed systems and methods, and describes several embodiments, adaptations, variations, alternatives and uses of the disclosed systems and methods. Various modifications and alterations could be made to the exemplary embodiments described herein without departing from the scope of the disclosures, and it is intended that all matter contained in the description or shown in the accompanying drawings shall be interpreted as illustrative and not necessarily limiting.

Described herein, among other things, are systems and methods for computer-aided real estate appraisal using homeowner-directed videography via a personal computer device. At a high level of generality, the systems and methods described herein comprise a self-inspection performed by a user who is not a professional appraiser via a mobile device, followed by a post-processing step in which the videographic data gathered by the user during the self-inspection is processed and analyzed. Finally, a professional analysis of the processed data is performed by a qualified real estate appraiser for purposes of issuing an appraisal report.

The systems and methods described herein facilitate the accurate and verifiable acquisition of videographic content for an appraisal report, without the need for a real estate appraiser to visit the property in person, while also controlling and limiting fraud or mistakes. The user's mobile device captures rich videographic data about the subject property in accordance with instructions or directions provided via software application downloaded to the mobile device, and the resulting videographic data is then uploaded to a remote server system for analysis and processing. The processed copies of the videographic data stored and managed by the server may then be made accessible over telecommunications network to one or more appraisers for use in conducting the appraisal of the property remotely.

In an embodiment, post-processing may be done before the real estate appraisers review the subject property to remove or redact potentially sensitive or confidential information in the image data, and various technologies may be deployed to further assist in the real estate appraisal process, such as by estimating the dimensions of the rooms, calculating the square footage, attempting to automatically categorize which type of rooms are present on the property, and using artificial intelligence to identify key attributes or features of the property that may be relevant to the appraisal. Machine learning models may be used to assess and determine the current state of the property based on the videographic data.

Throughout this disclosure, the term “computer” describes hardware that generally implements functionality provided by digital computers, particularly computing functionality associated with microprocessors. The term “computer” is not intended to be limited to any specific type of computing device unless specifically claimed or described as such, but rather it is intended to be inclusive of all digital computers, including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, headwear, pendants, fabrics, and clip-on devices.

As used herein, a “computer” should be understood as including the functionality provided by a computer outfitted with the hardware, software, peripherals, and accessories typical of computers in the particular role in which the computer is used. By way of example and not limitation, the term “computer” in reference to a laptop computer would be understood by one of ordinary skill in the art to include the functionality provided by pointer-based input devices, such as a mouse or track pad, whereas the term “computer” used in reference to a server would be understood by one of ordinary skill in the art to include functionality such as redundant power and storage systems.

Additionally, the term “computer” as used herein may be used to refer a single logical computer, but in practice, the functions of a “computer” described herein may be distributed across a plurality of physical devices. There are a number of techniques for distributing the workload, such as by function (e.g., specific machines in a system perform specific tasks) or by availability, such as where each machine in a group is capable of performing most or all functions and conducts processing tasks based available resources at a given point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices not conventionally thought of as “computers” nevertheless exhibit the characteristics of a “computer” in certain contexts. Where such a device is performing the functions of a “computer” as described herein, the term “computer” can be understood as including such devices to that extent. Devices of this type include but are not limited to: network hardware, print servers, file servers, NAS and SAN, load balancers, and any other hardware capable of interacting with the systems and methods described herein in the matter of a conventional “computer.”

As will be appreciated by one skilled in the art, some aspects of the present disclosure may be embodied as a system, method or process, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer-readable signal medium or a computer-readable storage medium (i.e., a non-transitory storage medium). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters.

Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a non-transitory computer- or machine-readable storage medium or memory.

Program code embodied on a computer readable medium may be transmitted using any appropriate medium, including but not limited to wireless, wireline, optical fiber cable, RF, etc., or any suitable combination of the foregoing.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the terms “web,” “web site,” “web server,” “web client,” and “web browser” refer generally to computers programmed to communicate over a network using the HyperText Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “GUI” generally refers to a graphical user interface for a computing device. The design, arrangement, components, and functions of a graphical user interface will necessarily vary from device to device depending on, among other things, screen resolution, processing power, operating system, device function or purpose, and evolving standards and tools for user interface design. One of ordinary skill in the art will understand that graphical user interfaces generally include a number of widgets, or graphical control elements, which are generally graphical components displayed or presented to the user and which can be manipulated by the user through an input device to provide user input, and which may also display or present to the user information, data, or output.

For purposes of this disclosure, there will also be discussion of a special type of computer referred to as a “mobile communication device” or simply “mobile device”. A mobile communication device may be, but is not limited to, a smart phone, tablet PC, e-reader, satellite navigation system, fitness device (e.g. a Fitbit™ or Jawbone™), smart watch or other wearable computer or any other type of mobile computer whether of general or specific purpose functionality. Generally speaking, a mobile communication device is network-enabled and communicating with a server system providing services over a telecommunication or other infrastructure network. A mobile communication device is essentially a mobile computer, but one that is commonly not associated with any particular location, is also commonly carried on a user's person, and usually is in near-constant real-time communication with a network.

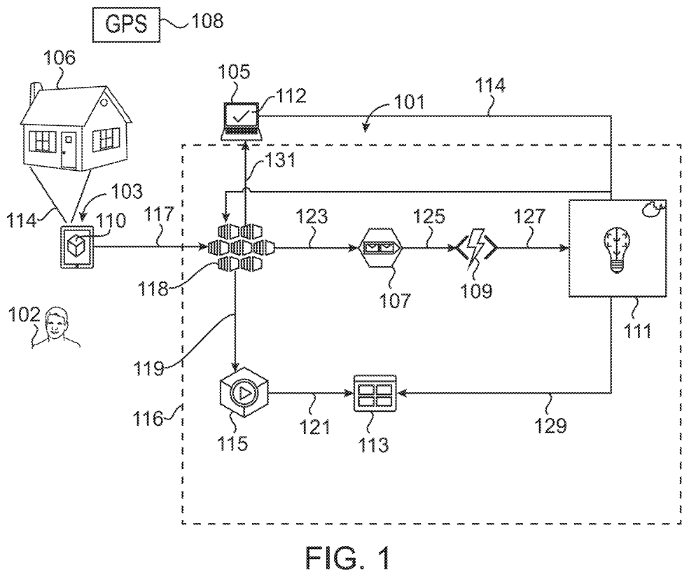

FIG. 1 depicts an embodiment of the systems and methods described herein. In the depicted embodiment (101), a user (102) manipulates a mobile device (103) to capture videographic data (104) of an appraisal property (106) to be appraised, referred to also as an “appraisal property.” The user (102) is generally the homeowner or occupant of the appraisal property (106), or another person associated with the appraisal property (106) or its owner or occupant(s), and is normally not experienced in appraisal, though the systems and methods could be used by an appraiser. The most common use case is that the user (102) has no particular appraisal experience. The mobile device (103) is generally a smart phone, tablet, wearable computer device (e.g., a virtual or augmented reality headset), a smart camera, or a similar type of handheld, carryable computer, but in an alternative embodiment, another type of computer having an imaging system for capturing videographic data could be used.

The systems and methods described herein may be implemented via a software application (110) executing on the mobile device (103). It is generally contemplated that the user (102) downloads the software application (110) from a distribution platform, but other methods of distribution are possible. The downloaded application (110) may include a graphical user interface (GUI) which the user (102) manipulates in order to perform the functions described herein.

The application (110) may in turn access an imaging system of the mobile device (103) and use the imaging system to acquire videographic data (which may include audio data) (104) as described elsewhere herein. In a typical embodiment, the user (102) uses his or her personal smart phone as the mobile device (103), as modern smart phones generally have a high-quality video camera built into the device. The application (110) is generally downloaded by a user (102) seeking to sell, pledge, or otherwise having a need to value a parcel of real estate, such as in connection with a refinancing, tax evaluation, and the like.

The depicted appraisal property (106) is a residential property, and this is the most common anticipated use case. However, the present disclosure is also applicable to other types of properties, including, but not limited to, commercial, industrial, and agricultural properties. Additionally, there may be uses outside of the real property context, such as appraising personal property. Likewise, there may be further applications outside of the appraisal industry.

The videographic data (104) captured by the mobile device (103) may be geo-tagged. Geotagging image data is the process of associating a geographical location with some or all of the images in the videographic data (104). In a simple form, this may be done by assigning a latitude and longitude to the videographic data (104), and potentially an altitude, bearing, or other locational or directional information. Typically, a geotagged photograph uses the detected geographic location of the mobile device (103) and associates that locational data with the videographic data (104), such as by storing the location in metadata. Modern smart phones and other similar types of mobile devices (103) may perform this type of geotagging automatically. This may be done using a geolocation system (108), such as the global positioning satellite (GPS) system, which communicates with a corresponding transceiver in the mobile device (103) to detect the current geolocation coordinates of the mobile device (103).

This geotagging data may be used to confirm that the appraisal property (106) is the correct property, such as by comparing the geotagged coordinates associated with the videographic data (104) to a known location of the appraisal property (106), or looking up the appraisal property (106) in a property database. Similarly, timestamps may be associated with the videographic data (104) to confirm that the videographic data (104) was acquired at the time claimed by the user (102). These features inhibit and reduce fraud and mistake.

The videographic data (104) may comprise stills, but, generally, video capture is preferred, and used to acquire videographic data (104) about the appraisal property (106). This may include 360-degree views, walk-throughs, panoramics, or guided video capture. The videographic data (104) may also include audio data captured in conjunction with video data.

The application (110) may prompt the user (102) to orient the mobile device (103) in portrait or landscape mode, to stand in a particular part of the room, or to hold the mobile device a certain way (103). Existing technologies for improving image quality may be used, such as steadying adjustment to compensate for hand shake, and automatic setting adjustments for use of flash, focus, brightness, and so forth.

Likewise, the user (102) may be provided with instructions to configure the environment to improve image quality, such as opening or closing curtains, turning lights on or off, or taking the images at a particular time of day. Instructions may also be provided to acquire videographic data (104) of the exterior of the appraisal property (106). The content and scope of the instructions may vary from embodiment to embodiment depending upon the type of appraisal property (106) expected to be appraised. In an embodiment, property-specific instructions may be provided. For example, an appraisal is typically commenced after the transaction in question has begun, at which point some basic information about the appraisal property (106) is known. As such, the party ordering the appraisal, such as the lender or buyer, may provide specific instructions for the property.

For example, if it is known that the appraisal property (106) includes a swimming pool, the application (110) may specifically prompt the user to image the pool, and provide instructions for how to do so, identify the aspects of the pool to image, including pumps, drains, and so forth. If the pool is presently full, the application may further provide prompts for how to configure the camera settings to minimize water reflection. Other unique features of any given parcel of property may also prompt property-specific instructions, such as garages, sheds, crawlspaces, three-season rooms, gardens, and so forth. These instructions may be downloaded to the application (110) via a telecommunications network.

During the self-inspection, the user (102) may also provide, and/or prompted by the application (110) to provide, information about the appraisal property (106) or various portions of the appraisal property (106). This may include providing the postal address of the appraisal property (106) and entering the date and time of the self-inspection. The user (102) may also provide a description or be prompted or given the opportunity to categorize each room or exterior view represented in the videographic data (104). The user (102) may also be able to enter room dimensions. As described elsewhere herein, in an embodiment, the application (110) may include additional features for determining the dimensions of a given room. The videographic data (104) acquired is initially stored on a memory of the mobile device (103) along with any other related data collected during the self-inspection process, such as location data, time data, room category, and room dimensions. This data may be collectively referred to herein as the “metadata” for the appraisal property (106) or the portion of the appraisal property (106) being imaged in the videographic data (104).

Once the self-inspection process in concluded, whether for the whole appraisal property (106) or a portion, the user (102) manipulates the GUI to cause the videographic data (104) and associated metadata to be transmitted over a telecommunications network, such as the public Internet, to a remote server (116) to conduct further image processing. This may be done, for example, by making an application programming interface (API) call (17) to determine where the information should be sent. This initial call (117) may establish or reserve various server (116) resources to be used to store the videographic data (104) related to the self-inspection. This API call (117) may return an upload address, such as a uniform resource locator (URL) for the application (110) to use for uploading the videographic data (104) and associated metadata. The application (110) may then cause the videographic data (104) to be uploaded to the provided URL.

Once uploaded, the videographic data (104) may be further analyzed and processed for various purposes before being made available to an appraiser for review. Certain artifacts or other elements in the videographic data may require special processing (111). For example, in the event that the images contain the faces of individuals, pets, children, religious symbols, or other private information not relevant to the appraised value of the property, these elements of the video may be removed, blurred, or redacted from the videographic data. Such elements are referred to herein as “privacy artifacts.” Likewise, errors may be identified and corrected if possible.

Other features of the videographic data (104) may be processed (111) to identify aspects of the appraisal property (106) evident in the videographic data (104) (which again may include accompanying audio) that are relevant to the appraisal. Such elements are referred to herein as “appraisal artifacts.” These elements are generally the same aspects an appraiser would consider while on-site, such as damage, lack of maintenance, needed repairs, evidence of neglect, and evidence of structural defects. The server (116) processing (111) may also identify potentially relevant aspects of the appraisal property (106) that are not readily apparent to the naked eye, such as minor bowing in walls, ceilings, or floors. Additionally, the videographic data (104) may include audio data, which can also provide relevant information, such as squeaking floors, noisy pipes, and the like.

Image processing (111) may include emphasizing or tagging specific appraisal artifacts in the videographic data (104), and may be represented in an index, which can then be searched by the appraiser to locate relevant information quickly. For example, if it is determined in the image processing (111) that the kitchen has a crack shown at the 3 minute and 22 second mark, the processed videographic data may be tagged at this time point so that an appraiser can jump straight to that part of the video to observe the crack. Likewise, the processed video may be augmented with locators or indicators to show where the crack was found. For example, a box may be drawn in the processed image data around the crack. This allows the appraiser to assess whether the crack is real, or is instead something else that may appear to be a crack, but is not. For example, an artificial intelligence system trained to process image data to identify cracks could mistakenly classify a stray cable hanging from a wall-mounted phone as a crack.

The processed and tagged video image data (129) is then stored along with the index of relevant locators, and made available to lenders and appraisers for review. These processed videos (129) may be accessed and viewed via an application (112) running on an appraiser computer (105), such as a desktop computer or an appraiser's own mobile device. As is known in the art, common authentication techniques may be used to preserve privacy and limit access. The appraiser application (112) may have a GUI which allows the lender or appraiser to search for the specific properties (106) being appraised to see whether the self-inspection videos (104) have been completed, uploaded, and processed (111) and are available for reviewing, or to check on the current status. The processed video (129) may then be used to make an appraisal and ultimately a transactional decision based on the appraisal.

This process may be done in series. For example, the user (102) may conduct a self-inspection as described herein for one room, and then submit the video and metadata for that room. The videographic data (104) may then be uploaded and processed (111) as described herein. The user (102) may then move onto the next room, and repeat the process. Alternatively, the user may use the application (110) to conduct the self-inspection for the entire appraisal property (106) then upload them in batches. The application (110) may provide the ability to organize a collection of videographic data (104) for one appraisal property (106), or the geo-location and/or time stamp data may be used by the server (116) to automatically determine which appraisal property (106) each video belongs to, and associate the information appropriately.

FIG. 1 also depicts an embodiment of the backend processing (111) aspect. In the depicted embodiment, a microservice (118) receives the raw videographic data (104) from the application (110), and places a message (123) into a queue (107) for image processing. Also, the depicted microservice (118) manages access policies and assets (119) for storage. In the depicted embodiment, a media service (115) is used to store the user-uploaded video (121) in a storage system (113), generally a non-transitory storage system. In the depicted embodiment, the storage system (113) is a blob storage system. This storage system (113) may store both the raw original unedited videographic data (104) received from the user (102), as well as the processed video (129). However, as described herein, end users of the appraiser application (112) generally will only have access to the processed video (129) to reduce or eliminate biased caused by the presence of irrelevant elements in the video, such as people or religious symbols, as well as to protect user privacy (e.g., privacy artifacts).

For the image processing, a queue trigger (125) may cause an appropriate functional application (109) to start the video processing (127). This may be done using a video processing module (11l) which has an artificial intelligence trained via machine learning. The results of the video processing (111) may be used as further training data. For example, if a user of the appraiser application (112) identifies people, pets, religious artifacts, or other privacy artifacts in the image data which should have been redacted but were not, the appraiser user may be able to, using the appraiser application (112) GUI, tag or identify those artifacts in the processed image data (129). This is effectively supervised learning, and the appraiser's classifications may be sent back (114) to the video processing module (111) to refine the classification engine. The video processing module (111) may then further redact the identified elements, and update the processed video feed in data storage (113) so that the next appraiser reviewing the processed image data does not see the unredacted privacy artifacts.

In an embodiment, ultimate the appraisal value may also be used to train an artificial intelligence to provide appraisal estimates based upon the training data. For example, the geolocation information, time stamps, image data, and final appraisal decision, potentially along with comparable properties used to make the appraisal decision, may be examined by an artificial intelligence to develop statistical models to predict or suggest an appraisal value for new properties to be appraised based on new data.

Additionally and/or alternatively, this artificial intelligence-generated appraisal may be used as a “sanity check” after an actual appraisal has been issued independently by a human appraiser based on that appraiser's analysis of the data. In this fashion, if a human-generated appraisal differs significantly from the machine-generated appraisal, the human-generated appraisal may be flagged for additional review and follow up to determine whether something was missed that would cause the appraisal to be either too high or too low. The machine-generated appraisal value could be hidden from the appraiser to prevent it from influencing the appraisal value.

Likewise, the machine-generated appraisal value could be used to assess appraiser performance. If a given AI consistently provide appraisals that are within a certain threshold distance from human appraisals, this suggests that the machine-generated appraisals are generally reasonable. However, if one specific appraiser is consistently well out of range, this suggests that additional training or performance improvement is needed for that appraiser to ensure that he or she is taking into account the same factors that other appraisers are.

Another aspect of the systems and methods is that the augmented reality functions of the hardware system on which the application (110) is running may be leveraged to provide various additional features. One such feature is estimated dimensions of the room. Augmented reality, also sometimes known as “AR”, causes the imaging system built in to the mobile device (103) to activate and capture live image data, which is then displayed on the screen on the mobile device (103). The ability of the mobile device (103) to track its own motion and orientation, such as pitch, tilt, and pan, allows the mobile device (103) to implement AR by overlaying on the displayed image transparent or opaque visual elements which correspond to the live video feed. As the user (102) moves the mobile device (103), the motion detection systems are coordinated with the image to resize and relocate the augmented reality elements shown on the screen to maintain synchrony with live data. Conceptually, this is similar to the ubiquitous “first down marker” commonly seen in television broadcasts of American football games.

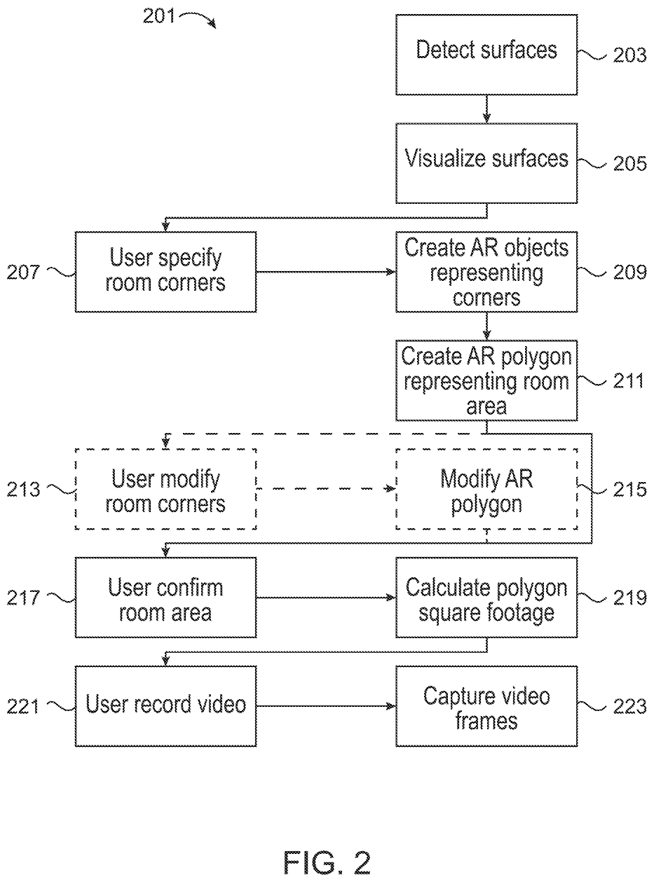

FIG. 2 depicts an embodiment of a method (201) for using the augmented reality capabilities to calculate the dimensions of a room. As the user enables the AR features, and begins to pan the camera around the space to be imaged, image processing and image recognition algorithms attempt to detect specific surfaces, chiefly room boundaries (203), in the image data, such as walls, ceilings, and floors. Next, the detected room boundaries are visualized (205) using augmented reality elements. For example, when the wall of a room is detected, a translucent or transparent AR element may be displayed on the screen of the user device in a location roughly corresponding to where that wall is shown on the display. Again, as the user moves, pans, and tilts the user device, the rendered AR element is reshaped, resized and relocated on the screen to correspond to the new location of the corresponding wall it represents in the display. This is repeated for as many surfaces the system is able to recognize in the image data until either all needed room boundaries are identified or the user otherwise indicates that he or she is ready to move on.

As the user pans and moves the camera, additional image data is gathered, and may be used to refine the detected surfaces, and to be able to display additional AR elements corresponding to those surfaces. Generally speaking, the displayed elements will be planes that correspond to the locations of the major room boundary surfaces, such as walls, ceilings, and floors.

Next, the user may manipulate the GUI to select specific AR elements corresponding to specific real world structures. For example, the user may be able to tap on the AR element corresponding to a wall or the floor to select that element. Once the user has selected an element, the user may then specify where the room corners are located (207). This may be done by the user selecting an element, which then causes another AR element to be displayed on the screen, in the nature of an anchor. This anchor will be a visual indication of where the system believes the corner is located. Again, the anchor will also move in the image as the camera is moved around the room. The user then moves the camera until the anchor is located on the image where the corner is actually located. Alternatively, the user may tap the anchor on the screen, and drag it to the location where the corner is located.

Once the anchor is matched to the corner, the user then indicates to the GUI that the anchor has been properly set, and the system will note the location of the anchor and fix it at that location for that corner. The user then repeats this process to identify at least all corners of a horizontal surface, such as the floor or ceiling to define a two-dimensional polygon representing the floor area of the room, or, preferably, all of the corners of the room, which in turn define three-dimensional polygon representing the entire room area (211).

This polygon may also be displayed as a transparent or semi-transparent AR element on the GUI, along with the set anchors marking the corners. The user may then pan and tilt the camera, causing the polygon to be re-rendered on the display in conformance to the corresponding real world surfaces that they represent. The user can experiment with this to confirm that the corners are properly set, and can modify or fine-tune (213) the corners by clicking on the corner anchors in the display and dragging them to the correct location. This will in turn modify the AR polygon (215) defining the room dimensions. Next, the user can indicate that the settings are final (217) and an algorithm is used to calculate the polygon's square footage (219) based on the dimensions of the AR object. Such algorithms take into account geometric and trigonometric concepts to estimate the dimensions of the sides of the polygon and, thereby, to calculate the surface area of each surface based on movement of the camera, the estimation of the distances moved, and the angles traversed. Some such algorithms are known in the art.

The user may also record a video of the space represented by the AR objects (221). Additionally, and/or alternatively, the process of the user conducting the AR estimation exercise may itself be recorded as videographic data (104), including the overlaid AR elements, so that a later appraiser or lender may review the video to confirm that the user identified the corners correctly, or reasonably close to correctly, and thus have documentary evidence in the appraisal file to support the square footage calculation.

This videographic data (104) video may then be uploaded to a server system for storage and processing, and made available for display to lenders or appraisers via a website interface, or other software application on a computer of the appraiser or lender. This will help to inhibit the incidence of fraud, and detect mistakes of the appraiser to request that the user re-perform the self-inspection to correct them. Additionally, before the footage is made available, it may be altered by detecting and removing privacy artifacts to both protect resident privacy and to inhibit the influence of bias. Again, if the video footage happens to catch people, pets, or religious or political symbols, those may be redacted from the video footage to protect the privacy of the homeowner, and to reduce the chances of subconscious bias influencing the treatment of the case. Some of all of the video frames captured may be provided or made available (223).

Though the present systems and methods are described with respect to a mobile device, it will be understood that other hardware systems may also be used in place of, or in supplement to, a mobile device, including, but not limited to, AR headsets and other wearable computing technology.

Another aspect of the systems and methods is correction or automatic detection of metadata concerning the property. A self-inspection may not result in the correct metadata being entered. For example, the classifications of room types are often defined with respect to building codes. For example, a room cannot be considered a bedroom suitable for human occupation if it does not have adequate egress in the event of a fire or other emergency. However, non-appraisers sometimes overlook these distinctions, and count rooms that are, functionally, bedrooms in the total bedroom count for the residence, even though, legally, they are not. Because the number of lawful bedrooms is generally the number used to market and promote the property to be sold, it is important that this data is accurate.

In an embodiment, the systems and methods may use computer vision to categorize video or other image data into groups associated with categorizations. For example, in the context of an appraisal, the presence in the video data of recognizable objects, such as a sofa, may be used to determine that the depicted space is a living room, or that the presence of a bed or a sink may indicate a bedroom or bathroom. These techniques may be used to determine, or verify, whether a self-inspection by a non-appraisal homeowner user has correctly identified the rooms depicted in videos that are submitted for appraisal purposes. These systems and methods may also be helpful in automated tagging of rooms based on the furniture found in them, which can be used by appraisers, lenders, or others to search the videos for content and retrieve relevant portions rather than having to review an entire recording.

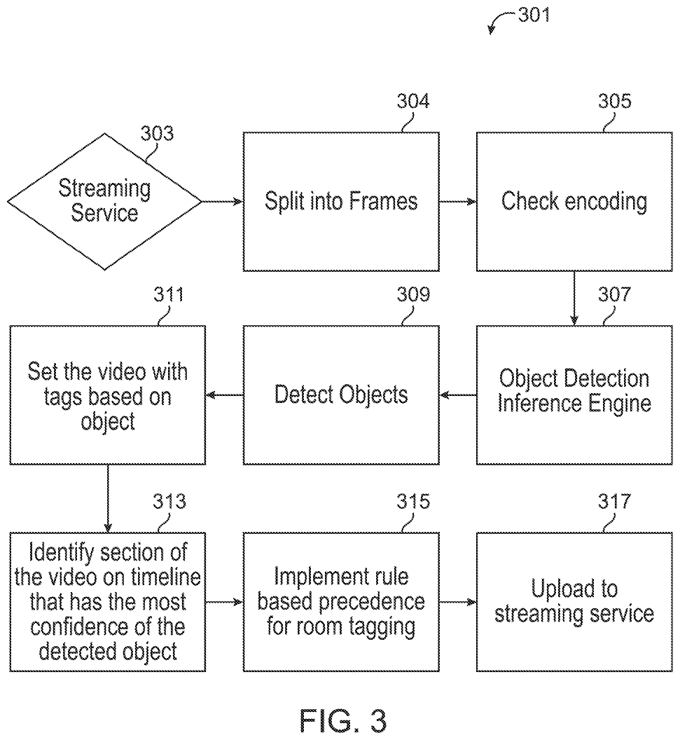

FIG. 3 depicts an embodiment of the systems and methods described herein implementing this functionality. In the depicted embodiment, an image streaming service (303) of a user mobile device is activated to capture image data about the real property to be appraised. As described elsewhere herein, this data may include videographic data (104) of the interior and exterior of the appraisal property (106). This videographic data (104) may be then uploaded to a server (116) for analysis and image processing, and then made available to an appraiser, lender, or other individual with a need to review and verify the data for whatever commercial purpose the appraisal is being performed. This streaming service (303) may be the video feed acquired directly at the mobile device, or may be a copy of that data uploaded to the server system. The streaming service (303) may be the raw unedited videographic data (104) from the phone, or may have already gone through one or more layers of post processing, such as to remove privacy artifacts.

The depicted streaming service (303) provides a series of video images, which may be a series of stills forming a video stream, or simply a set of stills taken at some interval. These images are then split into frames (304) and the encoding may be checked (305) to determine the most effective manner to identify objects in each frame. Next, an object detection inference engine (307) is used on one or more of the individual frames to detect recognizable objects in the frame. Such detection techniques may use known image processing and image recognition algorithms and techniques to find recognizable objects. Generally speaking, in the context of real estate appraisal, the types of objects sought to be identified will be common furniture or fixtures in a residence. This may include sofas, tables, chairs, sinks, countertops, fireplaces, televisions, end tables, beds, desks, bookshelves, windows, doors, bedroom furniture, and the like. Such objects are recognized in the image data and categorized (309). The object detection inference engine may be a separate software module or part of a general image post-processing artificial intelligence system.

Next, the video stream may be tagged (311) based on the detected object classifications. This may be done, by way of example and not limitation, by setting a marker at the timestamp in the image data corresponding to the point where the object was detected. This would allow a later reviewer to fast forward to that particular point in time to see the object and confirm. Alternatively, the detected object may be emphasized or identified in the image data by amending the stream to include an indicator, such as an arrow, box, and the like. Alternatively, both of these techniques may be used to tag the video stream with the detected objects.

Next, the section of the image feed which is determined as having the strongest correspondence to the detected object is identified (313). This may be done, by way of example and not limitation, by determining the first point in the video feed where the object is detected and the last point, and providing in a display a highlight or other visual indication spanning that portion of the video stream and providing a label or tag with what has been detected. For example, if at three minutes and thirty seconds in the video stream, a sofa and end table are detected, and then they are no longer found after four minutes and twelve seconds, the section of video the 3:30 to 4:12 time codes may be bracketed in a visual representation of the video time, and labeled with sofa, end table. Likewise, if multiple sections of the video are found to contain similar objects, the section that is most strongly correlated with related objects may be identified only. By way of example, and not limitation, end tables may also be found in bedrooms and living rooms. However, if the detection system finds end tables in connection with beds, but also finds end tables in connection with sofas, fireplaces, and televisions, the engine may determine that the latter segment is more likely to be the particular type of room.

Next, rule-based precedence is applied to tag the individual rooms (315). Again, depending on the type and nature of objects detected, which objects are detected together in the frame, the system may be able to determine what type of room is shown in the videographic data (104). Also, because, again, a given piece of furniture may be found in multiple types of rooms, as is also the case with fixtures, such as sinks, a precedence may be used. If, for example, the room cannot be determined with confidence because only an end table is found, the rules engine may determine that the default is living room, as opposed to bedroom. The structure and hierarchy of precedence may be based upon legal requirements, and may be designed to err on the side of caution by avoiding classification into categories with special significance, such as bedrooms and bathrooms. Thus, detection of a sink, with nothing else, may be assumed to be a kitchen or utility room, rather than a bathroom. Likewise, detection of an end table or dresser, but without the presence of a bed, may be preferentially tagged as a spare room or bonus room, as opposed to a bedroom.

Finally, the tagged video stream may be uploaded to another streaming service (317) or otherwise submitted for further processing.

These methods may be used to assist in providing the metadata related to self-inspection videographic data (104). This both provides a secondary check on any metadata provided directly by the user, and also identifies potential incidents of fraud or mistake. By comparing the data automatically determined with the data provided by the user, and where they differ, a manual review or intervention may be necessary to determine which is correct.

Another aspect of the systems and methods described herein is the need with mobile devices to transition the user experience from a mobile device screen to another device or technology, such as virtual reality, augmented reality, and mixed reality (sometimes collectively known as “extended reality” (XR). At present, there is no standard or conventional practice for this type of transition, which means that users may begin a process on a particular device, but realize part way through that the process is better carried out through a different type of device. However, transitioning from one to another generally requires an authentication step that currently is not possible.

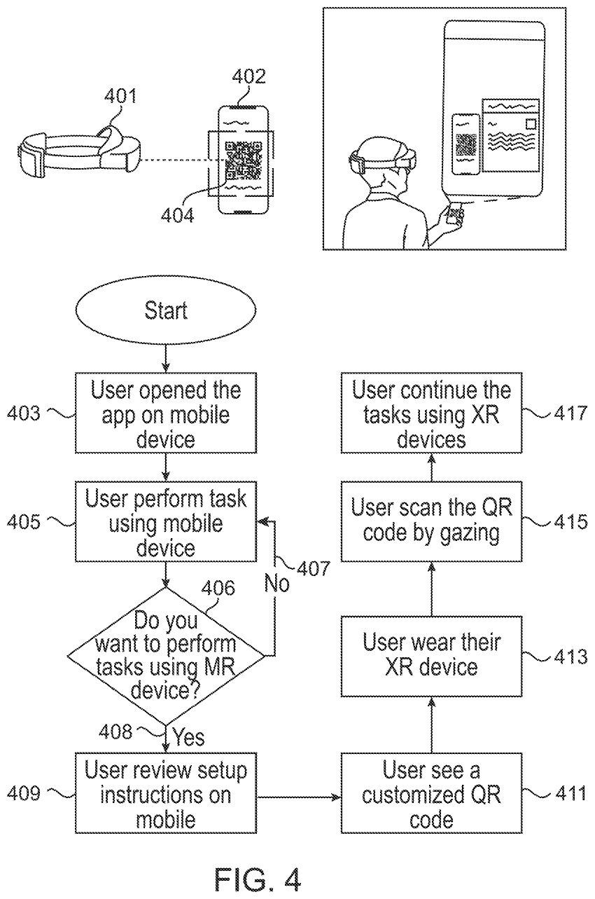

FIG. 4 depicts an embodiment of the systems and methods described herein for conducting such a transition. In the depicted embodiment, two devices are involved. A first device is the mobile device (402) associated with the user. A second device is an XR-enabled device (401). This second device (401) may alternatively be another mobile device, or maybe a different type of device entirely, such as wristwear or headwear. In the depicted embodiment, an XR-headwear (401) is depicted.

In the depicted embodiment, the user has opened or launched the application software on the user's mobile device (402) and is performing tasks (405) on the mobile device (402) using the application software. At some point, the user may desire to switch to perform tasks using an XR-device (406). In the meantime (407), the user may continue to perform tasks using the mobile device (402). However, once the user decides (408) to switch to the XR-device (401), the user may cause the authenticated user session on the mobile device (402) to display an image (404) that is associated or connected with the user's authenticated session on the mobile device (402). In the depicted embodiment, a QR-code is shown, but any type of image may be used. The image in question is uniquely generated and associated with the user's authenticated session on a server system, in a manner that is known in the art.

Next, the user wears or otherwise equips the XR-enabled device (413) and causes the imaging system on the device (401) to capture an image of the displayed image (404) on the user device (402). In the depicted embodiment, the second device (401) is headwear, so the user would put on the headwear, and look at the mobile device (402) to cause the camera in the headwear (401) to have within its field of view the image (404). The computer systems embedded in the headwear (401) would then use the scanned image to authenticate the same session on the headwear. That is, the scanned image may be associated with a uniform resource locator (URL) or may otherwise use an application programming interface (API) to contact an authentication server with the QR-code to authenticate the user's session on the second device (401) and transfer control to it. The user may then continue the tasks (417) using the XR-enabled device (401).

This provides the advantage of a connected XR-device (401) and mobile app being able to transfer session control from one to the other, and provides a solution for authentication and user identity verification steps when a user wants to shift use of the control software from the handheld device (402) to an XR-enabled device (401), without having to re-authenticate. Re-authenticating can cause a loss of session data and is frustrating for the user. In this fashion, the two devices are, in a sense, paired to achieve an omni-channel user experience that provides a bridge for XR-enabled devices (401) and mobile devices (402) to hand off sessions to one another in a simple and intuitive fashion without the need to re-enter passwords or other authentication tokens.

In the context of the self-inspection software, the user may begin the process using a mobile device (402), only to find it cumbersome and frustrating, and wish to switch to a headset (401) or other more convenient way of conducting the inspection. In this case, the user can scan the QR-code displayed on the mobile device (402) using the headwear (401) and the associated inspection order ID in the authenticated session on the user device (402) will be transferred to the headset (401). This is all done seamlessly, and without the user having to understand how the sessions are managed. When the session is finished on the XR-enabled device (401), the data may be uploaded to the server in the same manner as from the mobile, all seamlessly without the user experience being interrupted. In this fashion, the mobile application could become a companion for the inspection experience on extended reality devices, or vice versa.

Another common problem with appraisals using video, which may apply to a professional appraiser conducting an appraisal on site, but is especially applicable to the situation where a self-inspection appraisal is being done, is that the videographic data (104) may contain private or sensitive information which the appraiser should not see. This may be because the information is of a private nature, such as the presence of children in the video feed, or photographs of family members on the walls, or because the information is potentially sensitive and could improperly influence the appraisal value. This may include elements of the image data such as, but not necessarily limited to, religious symbology, political affiliations, and indications of profession, marital status, sexual orientation, and so forth.

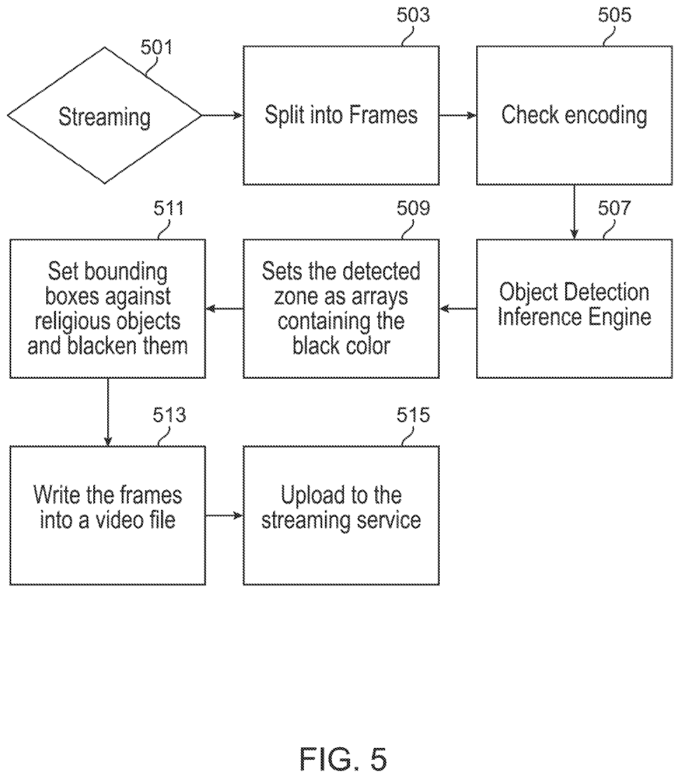

FIG. 5 depicts an embodiment of systems and methods for identifying and redacting such privacy artifacts. In the depicted embodiment, an image streaming service (501) is activated to capture videographic data (104) about the real appraisal property (106) to be appraised. As described elsewhere herein, this videographic data (104) may include a video recording of the interior and/or exterior of the appraisal property (106) in question. This recording may then be uploaded to a server (118) for analysis and image processing (111) and then made available to an appraiser, lender, or other individual with a need to review and verify the videographic data (104) for the commercial purpose for which the appraisal is being performed. This service (501) may comprise the videographic data (104) acquired directly at the mobile device (103), or it may be a copy of that data (104) uploaded to the server system (116).

The streaming (501) may be the raw unedited video footage (104) from the mobile device (103) or may have already gone through one or more prior processing steps. The stream (501) may then be split into frames (503), and then encoding may be checked (505) to determine the most effective manner to identify objects in the frame. Next, an object detection inference engine (507) may be used on one or more of the individual frames to detect recognizable objects. Such detection techniques may use known image processing and image recognition algorithms to find recognizable objects. The engine may also be trained to recognize such objects. Generally speaking, the types of objects to be recognized will be humans, as well as potentially sensitive, private personal information about the beliefs or lifestyle of the occupants of the appraisal property (106). The object detection inference engine may be a separate software module or part of a general image post-processing artificial intelligence system.

Next, the locations in each frame containing the detected sensitive objects may be obscured. This may be done by redacting, blurring, or otherwise rendering the objects in question incapable of being identified. This may be done by replacing the pixels in question with black pixels, white pixels, or by using algorithms to blur the image so that the items are not identifiable. Next, bounding boxes (511) may be established for the blacked out items, and the edited footage with the redacted sensitive information is then written (513) out to a processed video file (129). This file may then be uploaded or otherwise transferred (515) to the streaming service. Thus, the appraiser or other user of the appraiser computer (105) who reviews the processed video footage (129) will never see the private information contained in the original raw videographic data (104). In this fashion, sensitive information can be removed from the image to limit or inhibit the unfortunate influence of bias, as well as to protect the privacy of the occupants of the appraisal property (106).

The features of the systems and methods described herein may be used alone or in combination in any given embodiment. It will further be understood that ordinary methods for identifying and organizing related information in an on-line transaction may be deployed. For example, when an appraisal is ordered, a record of the order may be sent to and stored by the server (116), and associated with a unique identifier. The appraisal may also be associated with a specific property, or a specific occupant or user. Thus, when the user (102) uploads data for the appraisal property (106), these identifiers can be compared to ensure that the video data (104) is associated with the correct appraisal identifier. Thus, when the appraiser user pulls up the corresponding appraisal data on the appraisal computer (105), only the data for the appraisal property (106) in question is accessed. This further enhances privacy, and increases efficiency and ease of use of the systems and methods.

The systems and methods described herein am disclosed in the non-limiting, exemplary context of a real estate appraisal, but this is by no means limiting, and the systems and methods are suitable for use in other contexts as well. By way of example and not limitation, in a purchase transaction, the selling agent is the primary access contact for the appraisal inspection, and the system and methods may be used directly by the real estate agent. Also by way of example and not limitation, real estate agents are inspect properties for clients for purposes of listing the properties for sale. The systems and methods described herein could be used to complete the inspection, capture video/photos of the property, and collect data on the property in support of the listing process. Also by way of example and not limitation, the systems and methods described herein are suitable for use by real estate agents to conduct inspections for valuation purposes. For example, the systems and methods could be used for Broker Price Opinion (BPO) products (providing an estimate of the listing price of a property), which require an inspection and data collection.

The systems and methods described herein could also be used in the property inspection industry. For example, lenders may use the present systems and methods for portfolio management purposes. If a property is in danger of default, or in default, the systems and methods could be used by a property inspector to provide the lender with a view of the current condition of the property. In addition, a lender could use the systems and methods to evaluate the property to understand the equity in the home to assess removing a requirement for private mortgage insurance (PMI). The systems and methods described herein could also be used for disaster inspections or property condition reports. This could be done by a real estate agent, appraiser, or inspector. For example, the systems and methods could be used to provide the lender with a view of a property when a natural disaster occurs. The foregoing use cases are exemplary only and non-limiting.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for computer-aided appraisal of real estate comprising:
providing a mobile device of a user conducting a self-inspection appraisal of an appraisal property, said mobile device having an imaging system and a geolocation system;
providing an appraiser computer of an appraiser;
providing a server computer;
while said user is at said appraisal property, said user capturing videographic data about said appraisal property using said imaging system of said mobile device;
during said capturing;
said geolocation system geotagging at least some of said captured videographic data to create geolocation data representing at least one set of geographic coordinates at which said videographic data was captured;
said mobile device creating at least one timestamp representing a date and time at which said videographic data was captured;
storing said videographic data, said at least one set of geographic coordinates, and said at least one timestamp on a memory of said mobile device;
said mobile device transmitting to said server computer via a telecommunications network a copy of said stored videographic data, said at least one set of geographic coordinates, and said at least one timestamp;
receiving, at said server computer via said telecommunications network, said transmitted copy of said stored videographic data, said at least one set of geographic coordinates, and said at least one timestamp;
conducting, at said server computer, image processing on said received videographic data, said conducting being performed at least in part by an image processing artificial intelligence system;
storing said processed videographic data in a non-transitory memory;
accessing, by an appraiser using said appraiser computer, via a telecommunications network, said stored and processed videographic data; and
viewing, by said appraiser at said appraiser computer, said accessed videographic data; and
said appraiser determining an appraisal value for said appraisal property at least in part based upon said viewing.

2. The method of claim 1, further comprising confirming that said videographic data is for said appraisal property by, at said server computer, comparing said received geographic coordinates to an independently determined second set of geographic coordinates for said appraisal property.

3. The method of claim 1, further comprising confirming that said videographic data is current by, at said server computer, comparing said received timestamp data to the current date and time.

4. The method of claim 1, further comprising:
receiving, at said mobile device from said server computer over a telecommunications network, a set of instructions for conducting said capturing videographic data about said appraisal property, said instructions being specific to said appraisal property; and
wherein said capturing videographic data about said appraisal property comprises displaying, on a display of said mobile device, said received instructions.

5. The method of claim 1, wherein said capturing videographic data about said appraisal property using said imaging system of said mobile device comprises acquiring, at said mobile device, dimension data for at least one room of said appraisal property.

6. The method of claim 5, wherein said acquiring dimension data for said at least one room of said appraisal property includes using an augmented reality module to create a three-dimensional augmented reality model of said at least one room.

7. The method of claim 6, wherein said using an augmented reality module to create a three-dimensional augmented reality model of said at least one room comprises:
panning said mobile device to capture videographic data of said at least one room;
detecting at least one room boundary in said captured videographic data of said at least one room;
creating, in said augmented reality model, a geometric plane corresponding to said detected room boundary;
displaying, on a display of said mobile device, said geometric plane as an augmented reality element corresponding to said detected room boundary; and
repeating said panning, detecting, creating, and displaying.

8. The method of claim 7, further comprising:
said user manipulating a graphical user interface of said mobile device to identify in said augmented reality model a plurality of corners of said at least one room; and
said augmented reality module creating a polygon from said plurality of corners representing the rom boundaries of said at least one room; and
estimating the dimensions of said room by calculating the dimensions of the edges of said polygon.

9. The method of claim 1, wherein said conducting image processing on said received videographic data comprises:
identifying, in said received videographic data, at least one privacy artifact;
modifying said received videographic data to obscure said identified at least one privacy artifact; and
during said viewing, by said appraiser at said appraiser computer, said accessed videographic data, said at least one privacy artifact is unidentifiable by said appraiser.

10. The method of claim 9, wherein said at least one privacy artifact is selected from the group consisting of: a face; a pet; an indication of political or religious affiliation; an indication of marital status; an indication of sexual orientation; a photograph; text; and numbers.

11. The method of claim 9, wherein identifying, in said received videographic data, at least one privacy artifact comprises creating a plurality of still images from said videographic data and, using an object detection inference engine trained to recognize privacy artifacts, detecting in at least one still image of said plurality of still images said at least one privacy artifact.

12. The method of claim 11, wherein modifying said received videographic data to obscure said identified at least one privacy artifact comprises, at a location in said each at least one still image at which said at least one privacy artifact is detected, replacing the videographic data at said location with obscuring data.

13. The method of claim 12, wherein said obscuring data is at least one member of the group consisting of: black pixels; white pixels; random pixels; a blurring effect causing said at least one artifact to be unidentifiable.

14. The method of claim 1, wherein said conducting image processing on said received videographic data comprises:
identifying, in said received videographic data, at least one candidate appraisal artifact;
modifying said received videographic data to emphasize said at least one candidate appraisal artifact;
creating a time index for said received videographic data, said time index including a tag representing a point in time in said videographic data when said at least one candidate appraisal artifact is visible;
during said viewing, by said appraiser at said appraiser computer, said accessed videographic data, said appraiser indicating whether said at least one candidate appraisal artifact is an appraisal artifact; and
training, using said indication whether said at least one candidate appraisal artifact is an appraisal artifact, said image processing artificial intelligence system;

15. The method of claim 1, further comprising:
during said viewing, by said appraiser at said appraiser computer, said accessed videographic data:
indicating, by said appraiser, at least one non-obscured privacy artifact in said videographic data;
training, using said indicated non-obscured privacy artifact, said image processing artificial intelligence system; and
modifying said stored videographic data to obscure said indicated privacy artifact.

16. The method of claim 1, wherein said capturing videographic data about said appraisal property using said imaging system of said mobile device includes said user capturing videographic data about a plurality of rooms of said appraisal property and, for each room in said plurality of rooms, manipulating a graphical user interface of said mobile device to indicate a room classification for said each room.

17. The method of claim 16, wherein prior to said user manipulating said graphical user interface of said mobile device to indicate a room classification for said each room:
recognizing, by an imagine recognition module, in said videographic data, at least one object in said each room, said at least one object being associated with a room category; and
displaying, to said user via said graphical user interface, said room category as a suggested room classification for said each room.

18. The method of claim 1, wherein said mobile device comprises an extended reality headset.

19. The method of claim 1, further comprising:
at said server computer, an appraisal engine calculating an appraisal estimate for said appraisal property, said appraisal estimate based on said received videographic data, said at least one set of geographic coordinates, and said at least one timestamp.

20. The method of claim 19, further comprising:
comparing said appraisal value of said appraisal to said calculate appraisal estimate;
if the difference between said appraisal value of said appraisal and said calculate appraisal estimate exceeds a predefined threshold, a second appraiser reviewing said appraisal value.
